(19) United States
(12) Patent Application Publication
(10) Pub. No.: US 2023/0396408 A1
(43) Pub. Date: Dec. 7, 2023

(54) TRANSMITTING APPARATUS, RECEIVING APPARATUS, COMMUNICATION APPARATUS, WIRELESS COMMUNICATION SYSTEM, CONTROL CIRCUIT, STORAGE MEDIUM, TRANSMISSION METHOD, AND RECEPTION METHOD

(71) Applicant: MITSUBISHI ELECTRIC CORPORATION, Tokyo (JP)

(72) Inventors: Satoshi SASAKI, Tokyo (JP); Akinori NAKAJIMA, Tokyo (JP)

(73) Assignee: MITSUBISHI ELECTRIC CORPORATION, Tokyo (JP)

(21) Appl. No.: 18/234,612

(22) Filed: Aug. 16, 2023

Related U.S. Application Data
(63) Continuation of application No. PCT/JP2021/012363, filed on Mar. 24, 2021.

(51) Int. Cl. H04L 7/04; H04L 5/00; H04L 25/06

(52) U.S. Cl. CPC H04L 7/041; H04L 5/0003; H04L 25/067

(57) ABSTRACT

A mapping unit that modulates a transmission bit sequence to generate a modulated symbol sequence, a known sequence mapping unit that modulates a known bit sequence to generate a known symbol sequence, a selection unit that selects one of the modulated symbol sequence or the known symbol sequence and outputs the selected one as a transmission symbol sequence, and a DSTBC encoder that performs differential space-time block coding on the transmission symbol sequence are included. The known sequence mapping unit generates the known symbol sequence so that a matrix obtained by differential space-time block coding performed by the DSTBC encoder is a matrix with two rows and two columns that includes 0 in the first row and the first column, −1 in the second row and the first column, 1 in the first row and the second column, and 0 in the second row and the second column.

### CROSS-REFERENCE TO RELATED APPLICATION

This application is a continuation application of International Application PCT/JP2021/012363, filed on Mar. 24, 2021, and designating the U.S., the entire contents of which are incorporated herein by reference.

### BACKGROUND OF THE INVENTION

### 1. Field of the Invention

The present disclosure relates to a transmitting apparatus, a receiving apparatus, a communication apparatus, a wireless communication system, a control circuit, a storage medium, a transmission method, and a reception method for wireless communication.

### 2. Description of the Related Art

As a problem in wireless communication, performance degradation due to various types of interference is widely known. For example, a propagation path having frequency selectivity can distort a signal, preventing the signal from being correctly demodulated. This phenomenon is caused by delayed waves in a multipath environment. The way signals are distorted varies depending on the characteristics of a propagation path, that is, the number of delayed waves, the phase relationships between delayed waves, the magnitude of delayed waves, etc. When a plurality of base stations are installed, the plurality of base stations use the same frequency for effective frequency utilization. When the plurality of base stations use the same frequency, the plurality of base stations use the frequency at a distance from each other to prevent mutual interference. However, at a receiving apparatus that receives a transmission signal from a certain base station, a transmission signal from another base station using the same frequency can interfere, that is, what is called co-channel interference can occur, depending on geographical conditions, the position of the receiving apparatus, etc.

As a measure against co-channel interference including delayed waves, Patent Literature 1 discloses a technique to suppress interference signals included in reception signals received by a plurality of antennas by multiplying the reception signals by weights to adjust amplitude, phase, etc. and combining the reception signals. For the calculation of the weights to adjust amplitude, phase, etc., there are a weight calculation algorithm using a known sequence, a blind weight calculation algorithm, etc.

As techniques to reduce or prevent degradation in communication performance due to fading, diversity techniques are applied in wireless communication. For example, as a method of transmit diversity, there is a method in which a plurality of orthogonal sequences are generated by space-time block coding (STBC) and transmitted by different antennas. STBC allows receiving apparatuses to obtain full diversity gain.

STBC treats a plurality of symbols as one block. In general, the number of antennas is associated with the number of symbols treated as one block. For example, in STBC transmission with two antennas, two symbols are used as one block. To demodulate STBC symbols received by a receiving apparatus, it is necessary to estimate transmission path information. As a method that can obtain the effects of diversity by STBC and eliminates the need to estimate transmission path information, there is differential space-time block coding (DSTBC) in which differential coding is performed in units of blocks in STBC. For example, in DSTBC transmission with two antennas, a 2×2 matrix is generated with two symbols as one block, and differential coding is performed between matrices of two consecutive blocks. A receiving apparatus generates a 2×2 matrix using two symbols received, and performs differential decoding between matrices of two blocks for demodulation.

Patent Literature 1: Japanese Patent No. 6526348

When applying a weight calculation algorithm using a known sequence, a receiving apparatus needs to detect and generate an interference signal from reception signals to calculate weights. The technique described in Patent Literature 1 uses channel estimation to generate an interference signal. Channel estimation requires an inverse matrix operation. However, if a known sequence is not orthogonal, a desired signal cannot be completely separated from an interference signal, which results in a problem of reducing weight accuracy. Furthermore, to cope with both a delayed wave from the base station and co-channel interference from another base station, the delayed wave cannot be separated by an inverse matrix operation using a desired signal and an interference signal, and channel estimation considering the delayed wave is required to cope with the delayed wave, which results in a problem of increasing circuit scale.

### SUMMARY OF THE INVENTION

To solve the above problems and achieve an object, a transmitting apparatus according to the present disclosure includes: a mapping unit to modulate a transmission bit sequence to generate a modulated symbol sequence; a known sequence mapping unit to modulate a known bit sequence to generate a known symbol sequence; a selection unit to select one of the modulated symbol sequence or the known symbol sequence and output the selected one as a transmission symbol sequence; and an encoder to perform differential space-time block coding on the transmission symbol sequence. The known sequence mapping unit generates the known symbol sequence so that a matrix obtained by differential space-time block coding performed by the encoder becomes a matrix with two rows and two columns that includes 0 in the first row and the first column, −1 in the second row and the first column, 1 in the first row and the second column, and 0 in the second row and the second column.

### BRIEF DESCRIPTION OF THE DRAWINGS

FIG. 1 is a diagram illustrating a configuration example of a wireless communication system according to a first embodiment;

FIG. 2 is a diagram illustrating an example of a format of a transmission signal transmitted from a base station according to the first embodiment;

FIG. 3 is a block diagram illustrating a configuration example of a transmitting apparatus included in the base station according to the first embodiment;

FIG. 4 is a flowchart illustrating an operation of the transmitting apparatus included in the base station according to the first embodiment;

FIG. 5 is a diagram illustrating an example of an arrangement of modulated symbols when a mapping unit of the transmitting apparatus according to the first embodiment maps a transmission bit sequence using quadrature phase-shift keying;

FIG. 6 is a block diagram illustrating a configuration example of a receiving apparatus included in a mobile station according to the first embodiment;

FIG. 7 is a flowchart illustrating an operation of the receiving apparatus included in the mobile station according to the first embodiment;

FIG. 8 is a diagram illustrating an example of a configuration of processing circuitry when a processor and memory implement processing circuitry included in the transmitting apparatus according to the first embodiment;

FIG. 9 is a diagram illustrating an example of a configuration of processing circuitry when dedicated hardware constitutes the processing circuitry included in the transmitting apparatus according to the first embodiment;

FIG. 10 is a diagram illustrating a configuration example of a wireless communication system according to a second embodiment;

FIG. 11 is a diagram illustrating an example of a format of transmission signals transmitted from base stations according to the second embodiment; and

FIG. 12 is a diagram illustrating a configuration example of a wireless communication system according to a third embodiment.

### DETAILED DESCRIPTION OF THE PREFERRED EMBODIMENTS

Hereinafter, a transmitting apparatus, a receiving apparatus, a communication apparatus, a wireless communication system, a control circuit, a storage medium, a transmission method, and a reception method according to embodiments of the present disclosure will be described in detail with reference to the drawings. First Embodiment.

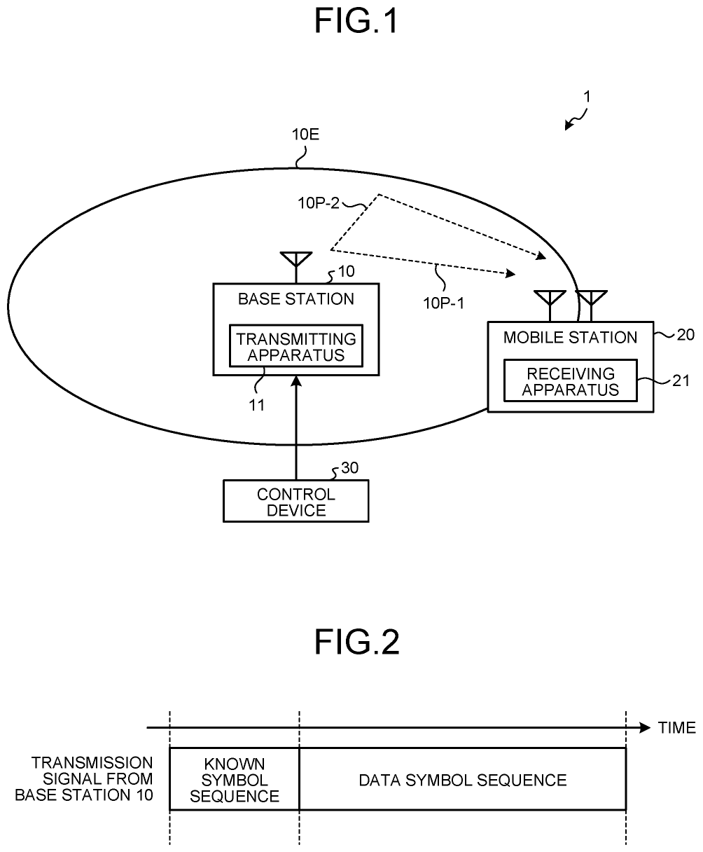

FIG. 1 is a diagram illustrating a configuration example of a wireless communication system 1 according to a first embodiment. The wireless communication system 1 includes a base station 10 forming a communication area 10E, a mobile station 20 that receives, from the base station 10, transmission signals that have each passed through two paths, a path 10P-1 and a path 10P-2, and a control device 30 that controls the base station 10. In the wireless communication system 1, the base station 10 is a communication apparatus that includes a transmitting apparatus 11 and wirelessly transmits a transmission bit sequence that is information received from the control device 30 as a transmission signal, based on control from the control device 30. The mobile station 20 is a communication apparatus that includes a receiving apparatus 21 and receives a transmission bit sequence that is information transmitted from the base station 10. The control device 30 transmits, to the base station 10, information to be wirelessly transmitted by the base station 10 and control information for the base station 10.

Although the single base station 10 and the single mobile station 20 are included in the wireless communication system 1 in FIG. 1, the number of the base stations 10 and the number of the mobile stations 20 included in the wireless communication system 1 are not limited to the example of FIG. 1. Furthermore, in the present embodiment, the base station 10 has a transmission function and the mobile station 20 has a reception function, but the mobile station 20 may have a transmission function and the base station 10 may have a reception function. Hereinafter, the present embodiment specifically describes a configuration where the single base station 10 and the single mobile station 20 are included as an example.

In FIG. 1, the mobile station 20 receives two signals, a transmission signal from the base station 10 that has passed through the path 10P-1 and a transmission signal from the base station 10 that has passed through the path 10P-2. At this time, if there is a difference between the path length of the path 10P-1 and the path length of the path 10P-2 as illustrated in FIG. 1, the transmission signal that has passed through the path 10P-1 and the transmission signal that has passed through the path 10P-2 reach the mobile station 20 at different timings, causing reception performance degradation in the mobile station 20. The mobile station 20 performs interference suppression to suppress the transmission signal that has passed through one of the paths. Hereinafter, in the present embodiment, the transmission signal that has passed through the path 10P-2 reaches after a delay with respect to the transmission signal that has passed through the path 10P-1, and the transmission signal that has passed through the path 10P-1 is treated as a preceding wave, and the transmission signal that has passed through the path 10P-2 as a delayed wave. In the present embodiment, the preceding wave is treated as a desired signal, and the delayed wave as an interference signal. The interference signal is suppressed in the mobile station 20. Note that the preceding wave may be treated as an interference signal, and the delayed wave as a desired signal.

In order for the mobile station 20 to perform interference suppression, the base station 10 inserts a known symbol sequence represented by complex numbers into a transmission signal. FIG. 2 is a diagram illustrating an example of a format of a transmission signal transmitted from the base station 10 according to the first embodiment. The format of a transmission signal illustrated in FIG. 2 has a configuration that the known symbol sequence is inserted before a data symbol sequence in which information to be transmitted by the base station 10 is represented by complex numbers. The mobile station 20 performs interference suppression processing using the known symbol sequence.

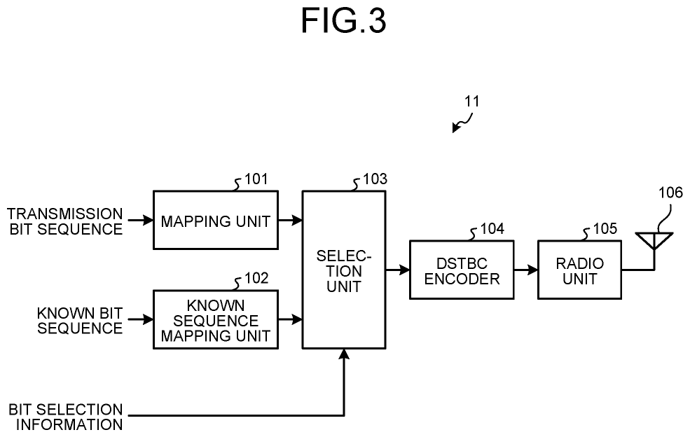

First, the configuration and operation of the transmitting apparatus 11 included in the base station 10 will be described. FIG. 3 is a block diagram illustrating a configuration example of the transmitting apparatus 11 included in the base station 10 according to the first embodiment. The transmitting apparatus 11 illustrated in FIG. 3 is configured to generate a transmission signal illustrated in FIG. 2. The transmitting apparatus 11 includes a mapping unit 101, a known sequence mapping unit 102, a selection unit 103, a DSTBC encoder 104, a radio unit 105, and an antenna 106. The mapping unit 101 maps a transmission bit sequence onto a complex plane as a modulated symbol sequence. The known sequence mapping unit 102 maps a known bit sequence onto a complex plane as a known symbol sequence. The selection unit 103 selects one of the modulated symbol sequence and the known symbol sequence, and outputs the selected one as a transmission symbol sequence. The DSTBC encoder 104 is an encoder that performs differential space-time coding on the transmission symbol sequence to generate DSTBC symbols. The radio unit 105 generates a transmission signal from the DSTBC symbols. The antenna 106 transmits the transmission signal generated by the radio unit 105.

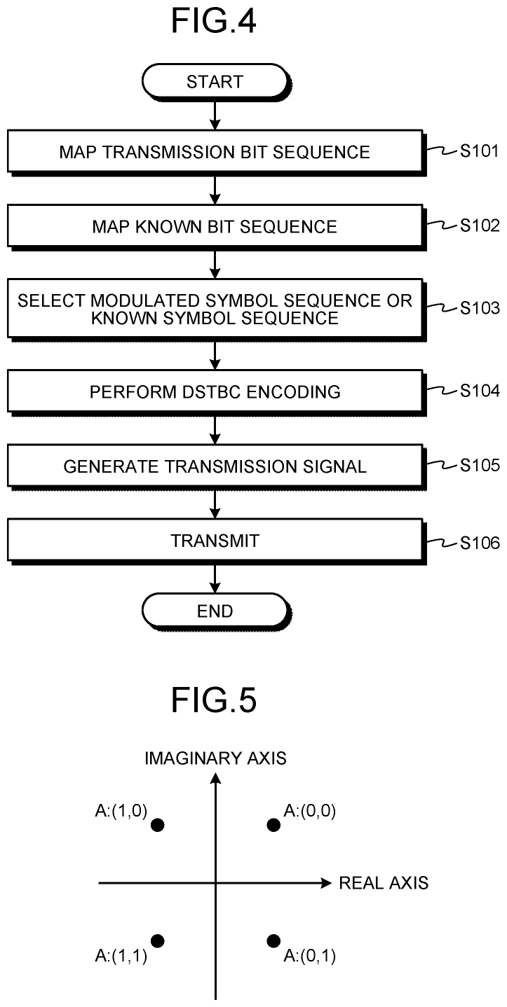

The operation of the transmitting apparatus 11 will be described. FIG. 4 is a flowchart illustrating the operation of the transmitting apparatus 11 included in the base station 10 according to the first embodiment. The mapping unit 101 modulates a transmission bit sequence acquired from the control device 30, that is, maps the transmission bit sequence into a symbol sequence represented by complex numbers (step S101) to generate a modulated symbol sequence, and outputs the modulated symbol sequence to the selection unit 103. The mapping unit 101 uses, for example, quadrature phase-shift keying (QPSK) as a mapping method. QPSK is a method of mapping two transmission bits into one symbol. The arrangement of modulated symbols in QPSK is as illustrated in FIG. 5. FIG. 5 is a diagram illustrating an example of an arrangement of modulated symbols when the mapping unit 101 of the transmitting apparatus 11 according to the first embodiment maps a transmission bit sequence using quadrature shift keying. In FIG. 5, the horizontal axis represents the real axis, and the vertical axis represents the imaginary axis. In QPSK, the mapping unit 101 maps two transmission bits as one symbol onto one of four points illustrated in FIG. 5. In the present embodiment, the modulation method is not limited to QPSK. Furthermore, in the example of FIG. 3, the base station 10 acquires a transmission bit sequence from the control device 30 and generates a modulated symbol sequence in the mapping unit 101, but may acquire a modulated symbol sequence itself from the control device 30.

The known sequence mapping unit 102 modulates the known bit sequence, that is, maps the known bit sequence into a symbol sequence represented by complex numbers (step S102) to generate a known symbol sequence, and outputs the known symbol sequence to the selection unit 103. The known sequence mapping unit 102 performs mapping intended for DSTBC encoding. For example, when DSTBC encoding is performed in units of two symbols, the known sequence mapping unit 102 performs mapping in units of two symbols. In the present embodiment, two known symbol sequences s₀[k, 1] and s₀[k, 2] output from the known sequence mapping unit 102 select one of two ways expressed by formula (1).

Formula 1:

(s₀[k, 1], s₀[k, 2])=(1,0), (0,1) (1)

The selection unit 103 selects one of the modulated symbol sequence acquired from the mapping unit 101 or the known symbol sequence acquired from the known sequence mapping unit 102, based on bit selection information included in the control information from the control device 30 (step S103), and outputs the selected one as a transmission symbol sequence.

The DSTBC encoder 104 performs DSTBC encoding on the transmission symbol sequence acquired from the selection unit 103 (step S104), and outputs the DSTBC-encoded symbol sequence as DSTBC symbols to the radio unit 105. In the following description, DSTBC encoding by the DSTBC encoder 104 is sometimes referred to as differential space-time block coding. As DSTBC encoding, the DSTBC encoder 104 generates a modulated symbol matrix S[k] with two modulated symbols of the transmission symbol sequence acquired from the selection unit 103 as one block. As shown in formula (2), the DSTBC encoder 104 multiplies the modulated symbol matrix S[k] by a DSTBC matrix C[k−1] one block before to generate a DSTBC matrix C[k], and outputs the DSTBC matrix C[k] as DSTBC symbols to the radio unit 105. Although several formulas are shown in formula (2) below, the several formulas are collectively referred to as formula (2). The same applies to cases where two or more formulas are shown in the following.

$$\begin{matrix}Formula 2 & \\ \begin{matrix}C [ k ] = S [ k ] C [ k - 1 ] \\ C [ k ] = [ \begin{matrix}c [ k , 1 ] & c [ k , 2 ] \\ - {c}^{*} [ k , 2 ] & {c}^{*} [ k , 1 ]\end{matrix} ] \\ S [ k ] = [ \begin{matrix}s [ k , 1 ] & s [ k , 2 ] \\ - {s}^{*} [ k , 2 ] & {s}^{*} [ k , 1 ]\end{matrix} ]\end{matrix} & ( 2 )\end{matrix}$$

At this time, k represents a block number, and k=1, 2, . . . . In the following description, a block with the block number k is referred to as a block k. s[k, 1] and s[k, 2] are two modulated symbols acquired by the DSTBC encoder 104 from the selection unit 103. s*[k, 1] and s*[k, 2] are the complex conjugates of s[k, 1] and −s[k, 2], respectively. As shown in formula (2), C[k] is required in the processing of the next block, and thus is output and internally held until the next processing. In formula (2), multiplication and addition and subtraction are performed on all elements as matrix operations. However, for example, only the two elements c[k, 1] and c[k, 2] may be calculated by a matrix operation, and c*[k, 1] and −c*[k, 2] may be calculated by exchanging signs, taking complex conjugates, etc. to reduce the amount of operation.

The DSTBC encoder 104 outputs, as the DSTBC symbols, c[k, 1] and −c*[k, 2], or c[k, 2] and c*[k, 1] in this order to the radio unit 105. In the present embodiment, the DSTBC encoder 104 outputs c[k, 1] and −c*[k, 2] in this order to the radio unit 105.

At the time of a first operation or initializing DSTBC encoding, the DSTBC encoder 104 replaces C[k−1] with an initial value C′. The initial value C′ is shown in formula (3).

$$\begin{matrix}Formula 3 & \\ {C}^{′} = [ \begin{matrix}{c}^{′} [ 1 ] & {c}^{′} [ 2 ] \\ - {c}^{′ *} [ 2 ] & {c}^{′ *} [ 1 ]\end{matrix} ] & ( 3 )\end{matrix}$$

If DSTBC encoding is initialized when the block number k is k′, C′ is expressed by formula (4).

Formula 4:

C[k′]=S[k′]C′ (4)

When the transmission symbol sequence output from the selection unit 103 is the known symbol sequence s₀[k, 1] and s₀[k, 2] input from the known sequence mapping unit 102, the DSTBC encoder 104 generates a DSTBC matrix C₀[k] expressed by formula (5) by DSTBC encoding.

$$\begin{matrix}Formula 5 & \\ \begin{matrix}{C}_{0} [ k ] = {S}_{0} [ k ] {C}_{0} [ k - 1 ] \\ {S}_{0} [ k ] = [ \begin{matrix}{s}_{0} [ k , 1 ] & {s}_{0} [ k , 2 ] \\ - {s}_{0}^{*} [ k , 2 ] & {s}_{0}^{*} [ k , 1 ]\end{matrix} ] \\ {C}_{0} [ k ] = [ \begin{matrix}{c}_{0} [ k , 1 ] & {c}_{0} [ k , 2 ] \\ - {c}_{0}^{*} [ k , 2 ] & {c}_{0}^{*} [ k , 1 ]\end{matrix} ]\end{matrix} & ( 5 )\end{matrix}$$

From formula (1), S₀[k] is equal to one of two types, J₀ and J₁, shown in formula (6).

$$\begin{matrix}Formula 6 & \\ \begin{matrix}{J}_{0} = [ \begin{matrix}1 & 0 \\ 0 & 1\end{matrix} ] \\ {J}_{1} = [ \begin{matrix}0 & 1 \\ - 1 & 0\end{matrix} ]\end{matrix} & ( 6 )\end{matrix}$$

At this time, when S₀[k] is J₀, formula (7) holds. When S₀[k] is J₁, formula (8) holds.

$$\begin{matrix}Formula 7 & \\ {C}_{0} [ k ] = [ \begin{matrix}{c}_{0} [ k - 1 , 1 ] & {c}_{0} [ k - 1 , 2 ] \\ - {c}_{0}^{*} [ k - 1 , 2 ] & {c}_{0}^{*} [ k - 1 , 1 ]\end{matrix} ] & ( 7 )\end{matrix}$$

$$\begin{matrix}Formula 8 & \\ {C}_{0} [ k ] = [ \begin{matrix}- {c}_{0}^{*} [ k - 1 , 2 ] & {c}_{0}^{*} [ k - 1 , 1 ] \\ - {c}_{0} [ k - 1 , 1 ] & - {c}_{0}^{*} [ k - 1 , 2 ]\end{matrix} ] & ( 8 )\end{matrix}$$

Thus, the known sequence mapping unit 102 generates a known symbol sequence so that a matrix obtained by DSTBC encoding performed by the DSTBC encoder 104 is a specific matrix. As described above, the known sequence mapping unit 102 generates a known symbol sequence so that the specific matrix includes 0 and 1, or includes 0, 1, and −1.

The radio unit 105 performs processing such as waveform shaping, digital/analog (D/A) conversion, upconversion, and amplification processing on the DSTBC symbols acquired from the DSTBC encoder 104 to generate a transmission signal (step S105), and transmits the transmission signal from the antenna 106 to the mobile station 20 (step S106). Processing to generate a transmission signal in the radio unit 105 is general processing and does not limit the present embodiment. In the present embodiment, the base station 10 is configured conforming to one transmitting antenna. However, the base station 10 may be configured conforming to two transmitting antennas since DSTBC is a transmit diversity technique. In this case, the base station 10 requires two radio units 105 and two antennas 106 for two transmitting antennas. In this case, the DSTBC encoder 104 outputs c[k, 1] and −c*[k, 2] in this order to one radio unit 105, and outputs c[k, 2] and c*[k, 1] in this order to the other radio unit 105.

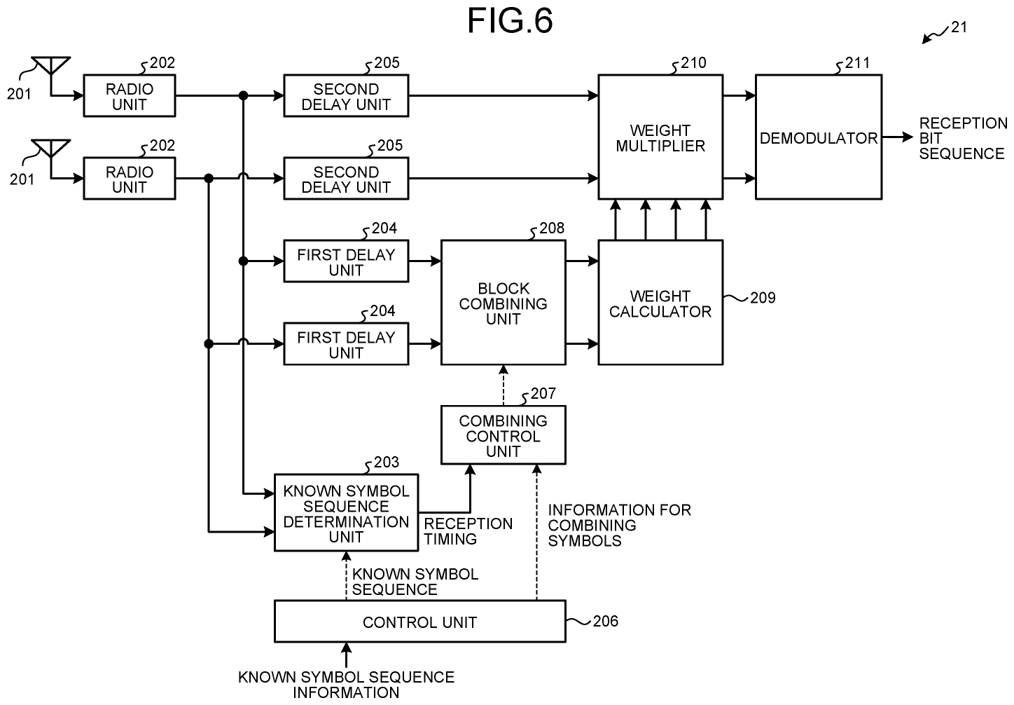

Next, the configuration and operation of the receiving apparatus 21 included in the mobile station 20 will be described. FIG. 6 is a block diagram illustrating a configuration example of the receiving apparatus 21 included in the mobile station 20 according to the first embodiment. The receiving apparatus 21 includes antennas 201, radio units 202, a known symbol sequence determination unit 203, first delay units 204, second delay units 205, a control unit 206, a combining control unit 207, a block combining unit 208, a weight calculator 209, a weight multiplier 210, and a demodulator 211.

Each antenna 201 receives transmission signals etc. transmitted from the base station 10. Each radio unit 202 generates a reception symbol sequence from a reception signal. The known symbol sequence determination unit 203 detects the reception timing of each known symbol sequence using the known symbol sequence. Each first delay unit 204 delays the reception symbol sequence by processing delay time of the known symbol sequence determination unit 203. Each second delay unit 205 delays the reception symbol sequence by time required for weight calculation. The control unit 206 performs control based on information on the known symbol sequence inserted into a desired signal. The combining control unit 207 specifies a combining method for the block combining unit 208 based on the reception timings and information for combining symbols. The block combining unit 208 combines the reception symbol sequences in units of DSTBC blocks and extracts interference signals. The weight calculator 209 calculates interference suppression weights from the interference signals. The weight multiplier 210 multiplies the reception symbol sequences by the interference suppression weights and further combines the reception symbol sequences to perform interference suppression on the reception symbol sequences. The demodulator 211 performs demodulation processing on the interference-suppressed reception symbol sequences to obtain a reception bit sequence. In FIG. 6, the number of the antennas 201 of the mobile station 20 is two, but the number of the antennas 201 is not limited to two. Hereinafter, the present embodiment will be described with the number of the antennas 201 of the mobile station 20 as two.

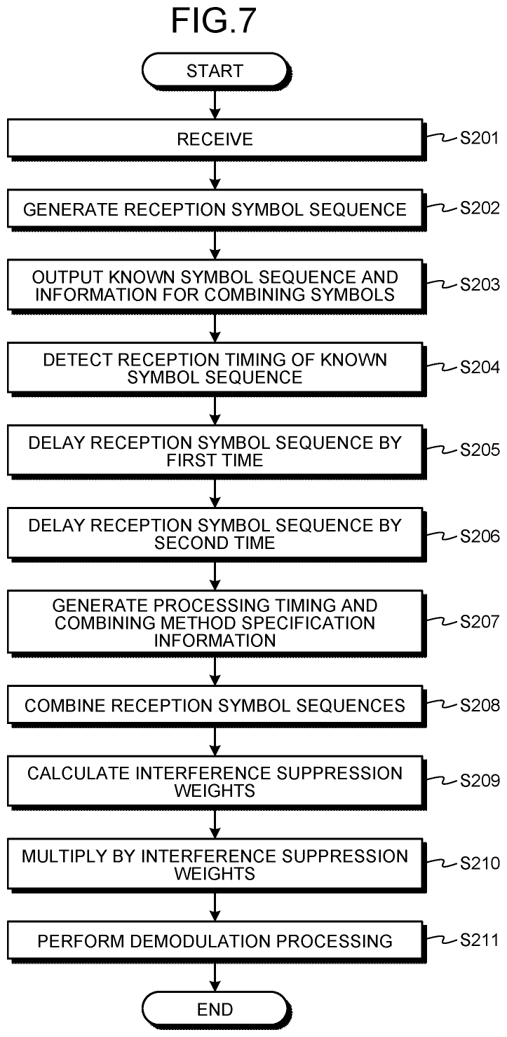

The operation of the receiving apparatus 21 will be described. FIG. 7 is a flowchart illustrating the operation of the receiving apparatus 21 included in the mobile station 20 according to the first embodiment. Each antenna 201 receives a signal in which transmission signals from the base station 10 are combined (step S201), and outputs the signal as a reception signal to the radio unit 202.

Each radio unit 202 performs processing such as amplification processing, downconversion, analog/digital (A/D) conversion, and waveform shaping on the reception signal acquired from the antenna 201 to generate a reception symbol sequence represented by complex numbers (step S202). Each radio unit 202 outputs the generated reception symbol sequence to the known symbol sequence determination unit 203, the first delay unit 204, and the second delay unit 205. Processing to generate a reception symbol sequence in each radio unit 202 is general processing, and does not limit the present embodiment.

The control unit 206 outputs the known symbol sequence to the known symbol sequence determination unit 203, based on known symbol sequence information indicating the known symbol sequence inserted into a desired signal input from the outside, and outputs the information for combining symbols to the combining control unit 207 (step S203).

The known symbol sequence determination unit 203 calculates the correlation between the reception symbol sequence acquired from each radio unit 202 and the known symbol sequence acquired from the control unit 206, and detects the position of the known symbol sequence inserted into the DSTBC-encoded reception symbol sequence, that is, the reception timing of the known symbol sequence (step S204). For example, the known symbol sequence determination unit 203 outputs, as the reception timing of the known symbol sequence, the timing at which the correlation value becomes maximum to the combining control unit 207.

Each first delay unit 204 delays the reception symbol sequence acquired from the radio unit 202 by a first time, specifically, a delay caused from processing by the known symbol sequence determination unit 203 and the combining control unit 207 (step S205). Thus, each first delay unit 204 ensures that the reception symbol sequence processed by the block combining unit 208 at a processing timing output from the combining control unit 207 is the known symbol sequence.

Each second delay unit 205 delays the reception symbol sequence acquired from the radio unit 202 by a second time, specifically, a processing delay required by the weight calculator 209 to calculate the interference suppression weights (step S206). Thus, the second delay unit 205 ensures that the weight multiplier 210 multiplies by the interference suppression weights from the head of the known symbol sequence inserted into the reception symbol sequence.

The combining control unit 207 generates the processing timing at which the block combining unit 208 combines reception symbols, based on information on the position of the known symbol sequence in each of the reception symbol sequences acquired from the known symbol sequence determination unit 203, that is, the reception timings of the known symbol sequences. The combining control unit 207 also generates combining method specification information for the block combining unit 208, based on the information for combining symbols acquired from the control unit 206 (step S207). The combining control unit 207 outputs the generated processing timing and combining method specification information to the block combining unit 208.

The block combining unit 208 combines the reception symbol sequence acquired from each first delay unit 204 with a reception symbol sequence having a different DSTBC block in units of DSTBC blocks at the processing timing acquired from the combining control unit 207, according to the combining method specification information acquired from the combining control unit 207 (step S208). When the transmission signal in the block k is c₀[k, 1] and −c₀*[k, 2], formula (9) holds where r_{0, n}[k, 1] and r_{0, n}[k, 2] are the reception symbol sequence in the block k acquired from the first delay unit 204 corresponding to a receiving antenna n. h₁, n[k, 1] and h_{1, n}[k, 2] are channel information on the path 10P-1, h_{2, n}[k, 1] and h_{2, n}[k, 2] are channel information on the path 10P-2, A[k, 1] and A[k, 2] are the amounts of variation of the delayed wave with respect to the preceding wave, and wₙ[k, 1] and wₙ[k, 2] are noise components.

Formula 9:

r_{0,n}[k,1]=h_{1,n}[k,1]c₀[k,1]+h_{2,n}[k,1](c₀[k,1]+Δ[k,1])+wₙ[k, 1] (9)

r_{0,n}[k,2]=h_{1,n}[k,2](−c₀*[k,2])+h_{2,n}[k,2](−c₀*[k,2]+Δ[k,2])+wₙ[k,2]

Here, suppose that variations in the channel information in the block k and a block k−1 can be ignored. When S₀[k] based on which c₀[k, 1] and c₀[k, 2] are generated is J₀, formula (10) holds.

$$\begin{matrix}Formula 10 & \\ \begin{matrix}\begin{matrix}{ri}_{n} [ k , 1 ] = {r}_{0 , n} [ k , 1 ] - {r}_{0 , n} [ k - 1 , 1 ] \\ = {h}_{2 , n} [ k , 1 ] ( Δ [ k , 1 ] - Δ [ k - , 1 ] ) + {w}_{n} [ k , 1 ] \\ - {w}_{n} [ k - 1 , 1 ]\end{matrix} \\ \begin{matrix}{ri}_{n} [ k , 2 ] = {r}_{0 , n} [ k , 2 ] - {r}_{0 , n} [ k - 2 , 2 ] \\ = {h}_{2 , n} [ k , 1 ] ( Δ [ k , 2 ] - Δ [ k - , 2 ] ) + {w}_{n} [ k , 2 ] \\ - {w}_{n} [ k - 1 , 2 ]\end{matrix}\end{matrix} & ( 10 )\end{matrix}$$

On the other hand, when S₀[k] based on which c₀[k, 1] and c₀[k, 2] are generated is J₁, formula (11) holds.

$$\begin{matrix}Formula 11 & \\ \begin{matrix}\begin{matrix}{ri}_{n} [ k , 1 ] = {r}_{0 , n} [ k , 1 ] - {r}_{0 , n} [ k - 1 , 2 ] \\ = {h}_{2 , n} [ k , 1 ] ( Δ [ k , 1 ] - Δ [ k - , 1 ] ) + {w}_{n} [ k , 1 ] \\ - {w}_{n} [ k - 1 , 1 ]\end{matrix} \\ \begin{matrix}{ri}_{n} [ k , 2 ] = {r}_{0 , n} [ k , 2 ] - {r}_{0 , n} [ k - 2 , 1 ] \\ = {h}_{2 , n} [ k , 1 ] ( Δ [ k , 2 ] - Δ [ k - , 2 ] ) + {w}_{n} [ k , 2 ] \\ - {w}_{n} [ k - 1 , 2 ]\end{matrix}\end{matrix} & ( 11 )\end{matrix}$$

In formulas (10) and (11), riₙ[k, 1] and riₙ[k, 2] are the interference signals. That is, when S₀[k] based on which c₀[k, 1] and c₀[k, 2] are generated is J₀, the block combining unit 208 can extract the interference signal by subtracting r[k−1, 1] from r[k, 1] and subtracting r[k−2, 2] from r[k, 2]. When S₀[k] based on which c₀[k, 1] and c₀[k, 2] are generated is J₁, the block combining unit 208 can extract the interference signals by adding r[k, 1] and r[k−1, 2] and subtracting r[k−2, 1] from r[k, 2]. As shown in formula (10) or (11), multiplication processing is not included in the extraction of the interference signal, so that the block combining unit 208 can accurately extract the interference signal without the occurrence of noise enhancement. Thus, the block combining unit 208 can extract the interference signals by combining the reception symbol sequences by adding or subtracting the symbols in units of DSTBC-encoded blocks at the processing timing.

The combining method specification information acquired by the block combining unit 208 from the combining control unit 207 is information indicating whether or not to extract the delayed wave using formula (10) or (11). The block combining unit 208 outputs the extracted delayed wave to the weight calculator 209. In the present embodiment, the block combining unit 208 performs combining processing on the consecutive blocks k and k−1. However, if variations in the transmission path information can be ignored, the combining processing does not necessarily have to be performed on consecutive blocks. For example, if variations in the transmission path information can be ignored between the block k and a block k−2, the block combining unit 208 may perform the combining processing on the block k and the block k−2.

The weight calculator 209 calculates the interference suppression weights for suppressing the interference signal riₙ[k, 1] and riₙ[k, 2], using the interference signal riₙ[k, 1] and riₙ[k, 2] acquired from the block combining unit 208 (step S209). For example, the weight calculator 209 calculates interference suppression weights w₀₀, w₁₁, w₀₁, and w₁₀ to achieve whitening. The weight calculator 209 outputs the calculated interference suppression weights to the weight multiplier 210.

The weight multiplier 210 performs interference suppression using the interference suppression weights acquired from the weight calculator 209 to obtain interference-suppressed reception symbol sequences. Specifically, the weight multiplier 210 multiplies the reception symbol sequence delayed by each second delay unit 205 by the interference suppression weights acquired from the weight calculator 209 (step S210). For example, when the weight multiplier 210 acquires the interference suppression weights w₀₀, w₁₁, w₀₁, and w₁₀ from the weight calculator 209, the interference-suppressed reception symbol sequence r′ₙ[k,1] and r′ₙ[k, 2] is expressed by formula (12). Formula 12:

r′₁[k,1]=w₀₀r₁[k,1]+w₀₁r₂[k,1]

r′₂[k,1]=w₁₀r₁[k,1]+w₁₁r₂[k,1]

r′₁[k,2]=w₀₀r₁[k,2]+w₀₁r₂[k,2]

r′₂[k,1]=w₁₀r₁[k,2]+w₁₁r₂[k,2]

The weight multiplier 210 outputs the interference-suppressed reception symbol sequences r′ₙ[k, 1] and r′ₙ[k, 2] to the demodulator 211.

The demodulator 211 performs demodulation processing on the interference-suppressed reception symbol sequence r′ₙ[k, 1] and r′ₙ[k, 2] acquired from the weight multiplier 210 (step S211) to generate a reception bit sequence.

Next, the hardware configuration of the transmitting apparatus 11 according to the first embodiment will be described. In the transmitting apparatus 11, the radio unit 105 is a communication device. The antenna 106 is an antenna element. The mapping unit 101, the known sequence mapping unit 102, the selection unit 103, and the DSTBC encoder 104 are implemented by processing circuitry. The processing circuitry may be memory storing a program and a processor that executes the program stored in the memory, or may be dedicated hardware. The processing circuitry is also referred to as a control circuit.

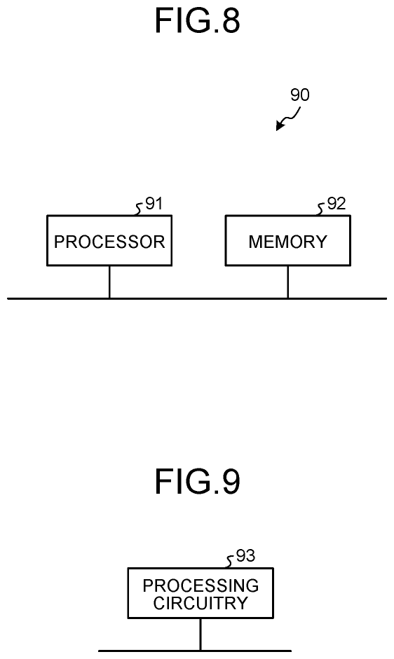

FIG. 8 is a diagram illustrating an example of the configuration of processing circuitry 90 when a processor 91 and memory 92 implement processing circuitry included in the transmitting apparatus 11 according to the first embodiment. The processing circuitry 90 illustrated in FIG. 8 is a control circuit and includes the processor 91 and the memory 92. When the processor 91 and the memory 92 constitute the processing circuitry 90, functions of the processing circuitry 90 are implemented by software, firmware, or a combining of software and firmware. The software or firmware is described as a program and stored in the memory 92. In the processing circuitry 90, the processor 91 reads and executes the program stored in the memory 92, thereby implementing the functions. That is, the processing circuitry 90 includes the memory 92 for storing the program that results in the execution of the processing in the transmitting apparatus 11. This program can be said to be a program for causing the transmitting apparatus 11 to perform the functions implemented by the processing circuitry 90. This program may be provided via a storage medium in which the program is stored, or may be provided via another means such as a communication medium.

The program can be said to be a program that causes the base station 10 to perform a first step in which the mapping unit 101 modulates a transmission bit sequence to generate a modulated symbol sequence, a second step in which the known sequence mapping unit 102 modulates a known bit sequence to generate a known symbol sequence, a third step in which the selection unit 103 selects one of the modulated symbol sequence or the known symbol sequence and outputs the selected one as a transmission symbol sequence, and a fourth step in which the DSTBC encoder 104 performs differential space-time block coding on the transmission symbol sequence. In the second step, the known sequence mapping unit 102 generates the known symbol sequence so that a matrix obtained by differential space-time block coding performed by the DSTBC encoder 104 becomes a specific matrix.

Here, the processor 91 is, for example, a central processing unit (CPU), a processing unit, an arithmetic unit, a microprocessor, a microcomputer, a digital signal processor (DSP), or the like. The memory 92 corresponds, for example, to nonvolatile or volatile semiconductor memory such as random-access memory (RAM), read-only memory (ROM), flash memory, an erasable programmable ROM (EPROM), or an electrically EPROM (EEPROM) (registered trademark), or a magnetic disk, a flexible disk, an optical disk, a compact disk, a mini disk, a digital versatile disc (DVD), or the like.

FIG. 9 is a diagram illustrating an example of the configuration of processing circuitry 93 when dedicated hardware constitutes the processing circuitry included in the transmitting apparatus 11 according to the first embodiment. The processing circuitry 93 illustrated in FIG. 9 corresponds, for example, to a single circuit, a combined circuit, a programmed processor, a parallel-programmed processor, an application-specific integrated circuit (ASIC), a field-programmable gate array (FPGA), or a combination of these. The processing circuitry 93 may be implemented partly by dedicated hardware and partly by software or firmware. Thus, the processing circuitry 93 can implement the above-described functions using dedicated hardware, software, firmware, or a combining of these.

The above has described the hardware configuration of the transmitting apparatus 11. The hardware configuration of the receiving apparatus 21 is the same. In the receiving apparatus 21, the antennas 201 are antenna elements. The radio units 202 are communication devices. The known symbol sequence determination unit 203, the first delay units 204, the second delay units 205, the control unit 206, the combining control unit 207, the block combining unit 208, the weight calculator 209, the weight multiplier 210, and the demodulator 211 are implemented by processing circuitry. The processing circuitry may be memory storing a program and a processor that executes the program stored in the memory, or may be dedicated hardware.

As described above, according to the present embodiment, the base station 10 including the transmitting apparatus 11 ensures that a matrix obtained when the DSTBC encoder 104 performs DSTBC encoding on the known symbol sequence is Jo or Ji. The mobile station 20 including the receiving apparatus 21 combines reception symbol sequences with different DSTBC-encoded block numbers. This allows the receiving apparatus 21 to extract an interference signal with high accuracy. The transmitting apparatus 11 can transmit a signal that allows the receiving apparatus 21 to accurately extract an interference signal.

### Second Embodiment

In the first embodiment, the single base station 10 is included, and a suppression target is a delayed wave. A second embodiment describes a configuration where the number of the base stations 10 is two, and co-channel interference in a wireless communication system is suppressed.

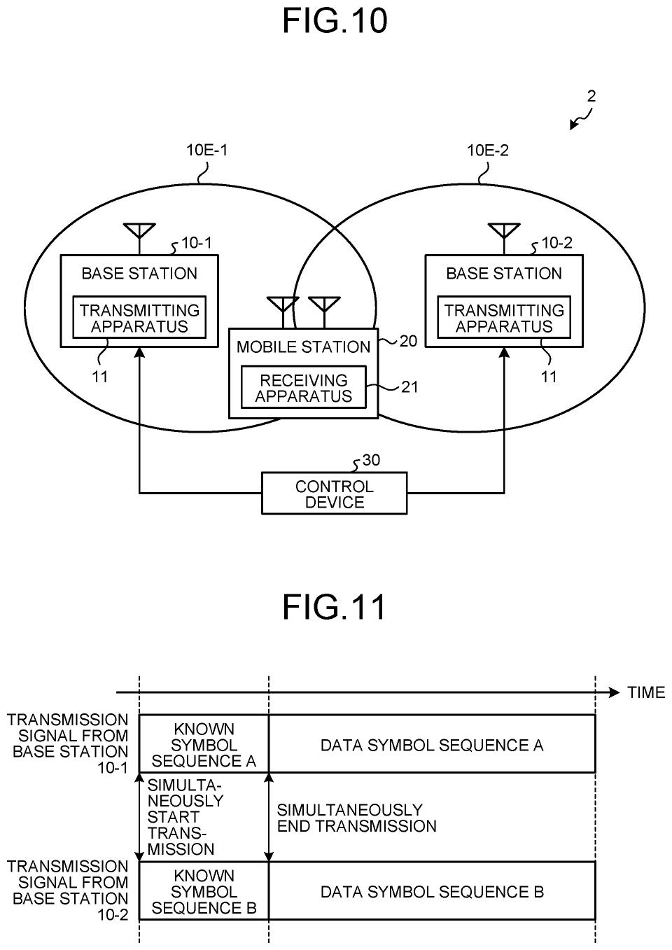

FIG. 10 is a diagram illustrating a configuration example of a wireless communication system 2 according to the second embodiment. The wireless communication system 2 includes a base station 10-1 forming a communication area a base station 10-2 forming a communication area the mobile station 20, and the control device 30 controlling the base stations 10-1 and 10-2. The transmission frequencies of the base station 10-1 and the base station 10-2 are the same. The communication area of the base station 10-1 and the communication area of the base station 10-2 overlap each other. Each of the base stations 10-1 and 10-2 wirelessly transmits a transmission bit sequence that is information received from the control device 30 as a transmission signal, based on control from the control device 30. The mobile station 20 receives a transmission bit sequence that is information transmitted from the base station 10-1 or the base station The control device 30 transmits, to the base stations 10-1 and 10-2, information to be wirelessly transmitted by the base stations 10-1 and 10-2 and control information for the base stations 10-1 and 10-2. The base stations 10-1 and 10-2 have the same configuration as the base station 10 of the first embodiment. In the following description, the base stations 10-1 and 10-2 are sometimes referred to as the base stations 10 when not distinguished from each other.

Although the two base stations 10 and the single mobile station 20 are included in the wireless communication system 2 in FIG. 10, the number of the base stations 10 and the number of the mobile stations 20 included in the wireless communication system 2 are not limited to the example of FIG. 10. Furthermore, in the present embodiment, the base stations 10-1 and 10-2 have a transmission function and the mobile station 20 has a reception function, but the mobile station 20 may have a transmission function and the base stations 10-1 and 10-2 may have a reception function. Hereinafter, the present embodiment specifically describes a configuration where the two base stations 10 and the single mobile station 20 are included as an example.

In FIG. 10, the position of the mobile station 20 is a point where the communication area 10E-1 of the base station 10-1 and the communication area 10E-2 of the base station 10-2 overlap each other. Consequently, the mobile station 20 receives a signal into which a transmission signal from the base station 10-1 and a transmission signal from the base station 10-2 are combined. When receiving a transmission signal from one base station 10, the mobile station 20 performs interference suppression since a transmission signal from the other base station 10 becomes co-channel interference. For example, when the mobile station 20 wants to receive a transmission signal from the base station 10-1, the mobile station 20 suppresses a reception signal from the base station 10-2 since a reception signal from the base station 10-1 is a signal desired to be received and the reception signal from the base station 10-2 is an interference signal that becomes a co-channel interference source.

In order for the mobile station 20 to perform interference suppression, each of the base stations 10-1 and 10-2 inserts a known symbol sequence represented by complex numbers into a transmission signal. Note that the known symbol sequence of the base station 10-1 and the known symbol sequence of the base station 10-2 are made different from each other. The base stations 10-1 and 10-2 transmit transmission signals in synchronization. The lengths of the known symbol sequences and the insertion positions of the known symbol sequences in the base stations 10-1 and 10-2 are the same. Thus, the transmission timings of the known symbol sequences inserted into the transmission signal from the base station 10-1 and the transmission signal from the base station 10-2 coincide with each other.

For example, in FIG. 10, the base station 10-1 inserts a known symbol sequence A into a transmission signal, and the base station 10-2 inserts a known symbol sequence B into a transmission signal. FIG. 11 is a diagram illustrating an example of a format of transmission signals transmitted from the base stations 10 according to the second embodiment. The format of the transmission signals illustrated in FIG. 11 has a configuration in which the known symbol sequence A is inserted before a data symbol sequence A in which information to be transmitted by the base station 10-1 is represented by complex numbers, and the known symbol sequence B is inserted before a data symbol sequence B in which information to be transmitted by the base station 10-2 is represented by complex numbers. The transmission signal from the base station 10-1 and the transmission signal from the base station 10-2 are synchronized. The timing at which the base station 10-1 transmits the known symbol sequence A and the timing at which the base station 10-2 transmits the known symbol sequence B are always the same, and the ending timings are also the same. In FIG. 11, the data symbol sequence A is transmitted from the base station 10-1, and the data symbol sequence B is transmitted from the base station 10-2. However, the same data symbol sequence may be transmitted from the base stations 10-1 and 10-2. The mobile station performs interference suppression processing using the known symbol sequence A and the known symbol sequence B. In the following description of the present embodiment, the known symbol sequence A is inserted into a transmission signal of the base station 10-1, and the known symbol sequence B is inserted into a transmission signal of the base station 10-2.

First, the configuration and operation of the base stations 10-1 and 10-2 will be described. As described above, the configuration of the base stations 10-1 and 10-2 is the same as the configuration of the base station 10 of the first embodiment illustrated in FIG. 3. However, for a known symbol sequence s_{0, 1}[k, 1] and s_{0, 1}[k, 2] output from the known sequence mapping unit 102 of the base station 10-1 and a known symbol sequence s_{0, 2}[k, 1] and s_{0, 2}[k, 2] output from the known sequence mapping unit 102 of the base station 10-2, formula (13) should always hold.

Formula 13:

s_{0,1}[k, 1]=−s_{0,2}[k, 1]

s_{0,1}[k, 2]=−s_{0,2}[k, 2] (13)

For example, when the output of the known sequence mapping unit 102 of the base station 10-1 satisfies formula (1), the output of the known sequence mapping unit 102 of the base station 10-2 satisfies formula (14).

Formula 14:

(s₀₂[k,1], s_{0.2}[k,2])=(−1,0),(0, −1) (14)

Next, the configuration and operation of the mobile station 20 will be described. The configuration of the mobile station 20 is the same as the configuration of the mobile station 20 of the first embodiment illustrated in FIG. 6. Here, in the present embodiment, formula (9) is expressed as formula (15). In the block k, the transmission signal from the base station 10-1 is c_{0,1}[k,1] and −c_{0,1}*[k,2], the transmission signal from the base station 10-2 is c_{0,2}[k,1] and −c_{0,2}*[k,2], hₙ[k,1] and hₙ[k,2] are information on a channel between the base station 10-1 and the receiving antenna n, and gₙ[k,1] and gₙ[k,2] are information on a channel between the base station 10-2 and the receiving antenna n.

Formula 15:

r_{0,n}[k,1]=hₙ[k, 1]c_{0,1}[k, 1]+gₙ[k, 1]c_{0,2}[k,1]+wₙ[k, 1]

r_{0,n}[k,2]=hₙ[k,2](−c_{0,1}*[k, 2])+gₙ[k, 2](−c_{0,2}*[k, 2])+wₙ[k, 2]

Here, suppose that variations in the channel information in the block k and the block k-1 can be ignored. When S₀[k] based on which c_{0,1}[k, 1] and c_{0,1}[k, 2] are generated is J₀, and formula (13) holds, formula (16) holds.

$$\begin{matrix}Formula 16 & \\ \begin{matrix}\begin{matrix}{ri}_{n} [ k , 1 ] = {r}_{0 , n} [ k , 1 ] - {r}_{0 , n} [ k - 1 , 1 ] \\ = 2 {g}_{n} [ k , 1 ] ( {c}_{0 , 2} [ k , 1 ] ) + {w}_{n} [ k , 1 ] - {w}_{n} [ k - 1 , 1 ]\end{matrix} \\ \begin{matrix}{ri}_{n} [ k , 2 ] = {r}_{0 , n} [ k , 2 ] - {r}_{0 , n} [ k - 2 , 2 ] \\ = 2 {g}_{n} [ k , 1 ] ( {c}_{0 , 2}^{*} [ k , 2 ] ) + {w}_{n} [ k , 2 ] - {w}_{n} [ k - 1 , 2 ]\end{matrix}\end{matrix} & ( 16 )\end{matrix}$$

On the other hand, when S₀[k] based on which c_{0,1}[k, 1] and c_{0,1}[k, 2] are generated is J₁, and formula (13) holds, formula (17) holds.

$$\begin{matrix}Formula 17 & \\ \begin{matrix}\begin{matrix}{ri}_{n} [ k , 1 ] = {r}_{0 , n} [ k , 1 ] - {r}_{0 , n} [ k - 1 , 2 ] \\ = 2 {g}_{n} [ k , 1 ] ( {c}_{0 , 2} [ k , 1 ] ) + {w}_{n} [ k , 1 ] - {w}_{n} [ k - 1 , 1 ]\end{matrix} \\ \begin{matrix}{ri}_{n} [ k , 2 ] = {r}_{0 , n} [ k , 2 ] - {r}_{0 , n} [ k - 2 , 1 ] \\ = 2 {g}_{n} [ k , 1 ] ( - {c}_{0 , 2}^{*} [ k , 2 ] ) + {w}_{n} [ k , 2 ] - {w}_{n} [ k - 1 , 2 ]\end{matrix}\end{matrix} & ( 17 )\end{matrix}$$

That is, by the base station 10-1 satisfying formula (1) and the base station 10-2 satisfying formula (13), the interference signals are combined in the same phase when the desired signals are canceled by formula (16) or formula (17). This allows the mobile station 20 to extract the interference signal with higher accuracy. If formula (18) is satisfied, the interference signals can be combined in the same phase when the desired signals are canceled by formula (19) or (20).

$$\begin{matrix}Formula 18 & \\ \begin{matrix}( {s}_{0 , 1} [ k , 1 ] , {s}_{0 , 1} [ k , 2 ] ) = ( {e}^{j ∅} , 0 ) , ( 0 , {e}^{j ∅} ) \\ ( {s}_{0 , 2} [ k , 1 ] , {s}_{0 , 2} [ k , 2 ] ) = ( {e}^{j ( ∅ + π )} , 0 ) , ( 0 , {e}^{j ( ∅ + π )} ) \\ {s}_{0 , 1} [ k , 1 ] = - {s}_{0 , 2} [ k , 1 ] \\ {s}_{0 , 1} [ k , 2 ] = - {s}_{0 , 2} [ k , 2 ]\end{matrix} & ( 18 )\end{matrix}$$

$$\begin{matrix}Formula 19 & \\ \begin{matrix}\begin{matrix}{ri}_{n} [ k , 1 ] = {r}_{0 , n} [ k , 1 ] - {r}_{0 , n} [ k - 1 , 1 ] {e}^{- j ∅} \\ = 2 {g}_{n} [ k , 1 ] ( {c}_{0 , 2} [ k , 1 ] ) + {w}_{n} [ k , 1 ] - {w}_{n} [ k - 1 , 1 ]\end{matrix} \\ \begin{matrix}{ri}_{n} [ k , 2 ] = {r}_{0 , n} [ k , 2 ] - {r}_{0 , n} [ k - 2 , 2 ] {e}^{- j ∅} \\ = 2 {g}_{n} [ k , 1 ] ( - {c}_{0 , 2}^{*} [ k , 2 ] ) + {w}_{n} [ k , 2 ] - {w}_{n} [ k - 1 , 2 ]\end{matrix}\end{matrix} & ( 19 )\end{matrix}$$

$$\begin{matrix}Formula 20 & \\ \begin{matrix}\begin{matrix}{ri}_{n} [ k , 1 ] = {r}_{0 , n} [ k , 1 ] + {r}_{0 , n} [ k - 1 , 2 ] {e}^{- j ∅} \\ = 2 {g}_{n} [ k , 1 ] ( {c}_{0 , 2} [ k , 1 ] ) + {w}_{n} [ k , 1 ] + {w}_{n} [ k - 1 , 1 ]\end{matrix} \\ \begin{matrix}{ri}_{n} [ k , 2 ] = {r}_{0 , n} [ k , 2 ] - {r}_{0 , n} [ k - 2 , 1 ] {e}^{- j ∅} \\ = 2 {g}_{n} [ k , 1 ] ( - {c}_{0 , 2}^{*} [ k , 2 ] ) + {w}_{n} [ k , 2 ] - {w}_{n} [ k - 1 , 2 ]\end{matrix}\end{matrix} & ( 20 )\end{matrix}$$

Note that in the present embodiment, the interference signals can be combined in the same phase, but the interference signals do not necessarily have to be made in the same phase when the desired signals are canceled. Furthermore, φ in formula (18) may be changed for each block k.

As described above, according to the present embodiment, the wireless communication system 2 includes the plurality of base stations 10, and the base stations and 10-2 each including the transmitting apparatus 11 use different known symbol matrices for the base stations Also in this case, the mobile station 20 including the receiving apparatus 21 can extract an interference signal with high accuracy with respect to a desired signal by combining reception symbol sequences with different DSTBC-encoded block numbers.

### Third Embodiment

The first and second embodiments have described the cases of communication from the base station 10 including the transmitting apparatus 11 to the mobile station 20 including the receiving apparatus 21. A third embodiment describes a communication apparatus including the transmitting apparatus 11 and the receiving apparatus 21.

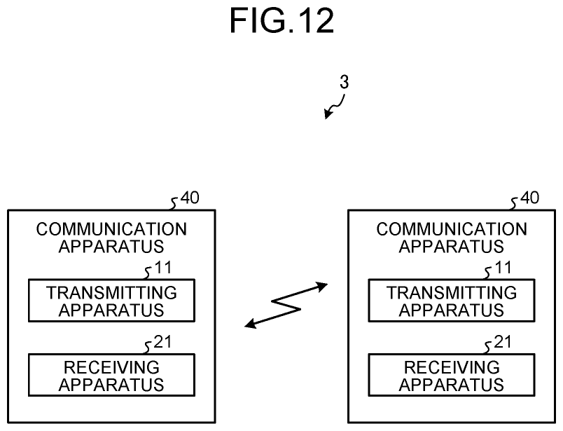

FIG. 12 is a diagram illustrating a configuration example of a wireless communication system 3 according to the third embodiment. The wireless communication system 3 includes two communication apparatuses 40. Each communication apparatus 40 includes the transmitting apparatus 11 and the receiving apparatus 21. Each of the transmitting apparatus 11 and the receiving apparatus 21 has the functions described in the first or second embodiment. That is, in the wireless communication system 3, the communication apparatuses 40 can communicate bidirectionally. Note that the wireless communication system 3 may be configured to include three or more communication apparatuses 40.

The transmitting apparatus according to the present disclosure has the effect of being able to transmit a signal that allows a receiving apparatus to accurately extract an interference signal.

The configurations described in the above embodiments illustrate an example and can be combined with another known art. The embodiments can be combined with each other. The configurations can be partly omitted or changed without departing from the gist.

What is claimed is:

1. A transmitting apparatus, comprising:
processing circuitry
to modulate a transmission bit sequence to generate a modulated symbol sequence;
to modulate a known bit sequence to generate a known symbol sequence;
to select one of the modulated symbol sequence or the known symbol sequence and output the selected one as a transmission symbol sequence; and
to perform differential space-time block coding on the transmission symbol sequence, wherein
the processing circuitry generates the known symbol sequence so that a matrix obtained by differential space-time block coding performed by the encoder becomes a matrix with two rows and two columns that includes 0 in the first row and the first column, −1 in the second row and the first column, 1 in the first row and the second column, and 0 in the second row and the second column.

2. A receiving apparatus, comprising:
processing circuitry
to detect a reception timing of a known symbol sequence from each of reception symbol sequences encoded by differential space-time block coding in a transmitting apparatus, using the known symbol sequence;
to generate a processing timing to combine the reception symbol sequences, based on the reception timings; and
to combine the reception symbol sequences at the processing timing by adding or subtracting symbols in units of blocks of differential space-time block coding, to extract interference signals, wherein
the known symbol sequence is generated so that a matrix obtained by differential space-time block coding in the transmitting apparatus is a matrix with two rows and two columns that includes 0 in the first row and the first column, −1 in the second row and the first column, 1 in the first row and the second column, and 0 in the second row and the second column.

3. The receiving apparatus according to claim 2, wherein the processing circuitry further calculates interference suppression weights to suppress the interference signals, using the interference signals.

4. The receiving apparatus according to claim 3, the processing circuitry multiplies the reception symbol sequences by the interference suppression weights to suppress the interference signals of the reception symbol sequences.

5. A communication apparatus, comprising:
a transmitting apparatus, comprising:
processing circuitry
to modulate a transmission bit sequence to generate a modulated symbol sequence;
to modulate a known bit sequence to generate a known symbol sequence;
to select one of the modulated symbol sequence or the known symbol sequence and output the selected one as a transmission symbol sequence; and
to perform differential space-time block coding on the transmission symbol sequence, wherein
the processing circuitry generates the known symbol sequence so that a matrix obtained by differential space-time block coding performed by the encoder becomes a matrix with two rows and two columns that includes 0 in the first row and the first column, −1 in the second row and the first column, 1 in the first row and the second column, and 0 in the second row and the second column; and
the receiving apparatus according to claim 2.

6. A wireless communication system, comprising:
a transmitting apparatus, comprising:
processing circuitry
to modulate a transmission bit sequence to generate a modulated symbol sequence;
to modulate a known bit sequence to generate a known symbol sequence;
to select one of the modulated symbol sequence or the known symbol sequence and output the selected one as a transmission symbol sequence; and
to perform differential space-time block coding on the transmission symbol sequence, wherein
the processing circuitry generates the known symbol sequence so that a matrix obtained by differential space-time block coding performed by the encoder becomes a matrix with two rows and two columns that includes 0 in the first row and the first column, −1 in the second row and the first column, 1 in the first row and the second column, and 0 in the second row and the second column; and
the receiving apparatus according to claim 2.

7. The wireless communication system according to claim 6, wherein
the wireless communication system comprises a plurality of the transmitting apparatuses, and the plurality of transmitting apparatuses use known symbol sequences different from each other.

8. A control circuit to control a transmitting apparatus, the control circuit causing the transmitting apparatus to perform:
modulating a transmission bit sequence to generate a modulated symbol sequence;
modulating a known bit sequence to generate a known symbol sequence;
selecting one of the modulated symbol sequence or the known symbol sequence and outputting the selected one as a transmission symbol sequence; and
differential space-time block coding on the transmission symbol sequence, wherein
the known symbol sequence is generated so that a matrix obtained by differential space-time block coding becomes a matrix with two rows and two columns that includes 0 in the first row and the first column, −1 in the second row and the first column, 1 in the first row and the second column, and 0 in the second row and the second column.

9. A control circuit to control a receiving apparatus, the control circuit causing the receiving apparatus to perform:
detecting a reception timing of a known symbol sequence from each of reception symbol sequences encoded by differential space-time block coding in a transmitting apparatus, using the known symbol sequence;
generating a processing timing to combine the reception symbol sequences, based on the reception timings; and
combining the reception symbol sequences at the processing timing by adding or subtracting symbols in units of blocks of differential space-time block coding, to extract interference signals, wherein
the known symbol sequence is generated so that a matrix obtained by differential space-time block coding in the transmitting apparatus is a matrix with two rows and two columns that includes 0 in the first row and the first column, −1 in the second row and the first column, 1 in the first row and the second column, and 0 in the second row and the second column.

10. A storage medium storing a program to control a transmitting apparatus,
the program causing the transmitting apparatus to perform:
modulating a transmission bit sequence to generate a modulated symbol sequence;
modulating a known bit sequence to generate a known symbol sequence;
selecting one of the modulated symbol sequence or the known symbol sequence and outputting the selected one as a transmission symbol sequence; and
differential space-time block coding on the transmission symbol sequence, wherein
the known symbol sequence is generated so that a matrix obtained by differential space-time block coding becomes a matrix with two rows and two columns that includes 0 in the first row and the first column, −1 in the second row and the first column, 1 in the first row and the second column, and 0 in the second row and the second column.

11. A storage medium storing a program to control a receiving apparatus,
the program causing the receiving apparatus to perform:
detecting a reception timing of a known symbol sequence from each of reception symbol sequences encoded by differential space-time block coding in a transmitting apparatus, using the known symbol sequence;
generating a processing timing to combine the reception symbol sequences, based on the reception timings; and
combining the reception symbol sequences at the processing timing by adding or subtracting symbols in units of blocks of differential space-time block coding, to extract interference signals, wherein
the known symbol sequence is generated so that a matrix obtained by differential space-time block coding in the transmitting apparatus is a matrix with two rows and two columns that includes 0 in the first row and the first column, −1 in the second row and the first column, 1 in the first row and the second column, and 0 in the second row and the second column.

12. A transmission method, comprising:
modulating a transmission bit sequence to generate a modulated symbol sequence;
modulating a known bit sequence to generate a known symbol sequence;
selecting one of the modulated symbol sequence or the known symbol sequence and outputting the selected one as a transmission symbol sequence; and
performing differential space-time block coding on the transmission symbol sequence, wherein
in the modulating the known bit sequence, the known symbol sequence is generated so that a matrix obtained by differential space-time block coding becomes a matrix with two rows and two columns that includes 0 in the first row and the first column, −1 in the second row and the first column, 1 in the first row and the second column, and 0 in the second row and the second column.

13. A reception method, comprising:
detecting a reception timing of a known symbol sequence from each of reception symbol sequences encoded by differential space-time block coding in a transmitting apparatus, using the known symbol sequence;
generating a processing timing to combine the reception symbol sequences, based on the reception timings; and
combining the reception symbol sequences at the processing timing by adding or subtracting symbols in units of blocks of differential space-time block coding, to extract interference signals, wherein
the known symbol sequence is generated so that a matrix obtained by differential space-time block coding in the transmitting apparatus is a matrix with two rows and two columns that includes 0 in the first row and the first column, −1 in the second row and the first column, 1 in the first row and the second column, and 0 in the second row and the second column.
